(19) United States
(12) Patent Application Publication
(10) Pub. No.: US 2018/0189465 A1
(43) Pub. Date: Jul. 5, 2018

(54) MESSAGE PROVIDING AND ASSESSMENT SYSTEM

(71) Applicant: DEUTSCHE TELEKOM AG, Bonn (DE)

(72) Inventors: Matthias RENKEN, Bremen (DE); Robert Manfred ALBRECHT, Oldenburg (DE)

(21) Appl. No.: 15/739,588

(22) PCT Filed: Jun. 1, 2016
(86) PCT No.: PCT/EP2016/062327

§ 371 Date: Dec. 22, 2017

(30) Foreign Application Priority Data
Jun. 26, 2015 (DE) 10 2015 110 366.4

(51) Int. Cl. G06F 21/31; H04L 12/58; H04L 29/06; H04L 9/32

(52) U.S. Cl. CPC G06F 21/31; H04L 51/04; H04W 4/12; H04L 9/32; H04L 63/083

(57) ABSTRACT

A message providing and assessment system, with: a user database for storing user information; a message database for storing messages; a message interface for receiving messages; a registration module; a message gathering module; a message providing module; and a message assessment module which is arranged to receive an assessment request for assessment of the messages provided in the memory area accessible via the public communication network with an attribute value via a communication network; and which is furthermore arranged, in response to receiving the assessment request, to update an assessment attribute assigned to the user identifier of the provided messages on the basis of the received attribute value in the user database.

The present invention relates to a message providing and assessment system and a method for providing and assessing messages, in particular for the trusted and anonymous publication of information. The invention furthermore relates to a method and a device for the electronic publication of information in which the identity of the publishing party remains confidential, but a level of trust in the publishing party provides information on the reliability of the information.

In current communications, there are increasing amounts of information which, on the one hand, are of great significance to the general public, but, on the other hand, the publication of the information or messages represents a high personal risk to the publishing party. Examples of this include the publication of secret service documents relating to possible illegal eavesdropping practices which affect a large proportion of the population or the expression of opinions on terrorist attacks, wherein newspaper editors and journalists have to expect attempts on their lives if they report on attacks or background information.

The possibility of publishing documents via platforms such as e.g. Wikileaks already existed in the past. Employees of the platform carried out the confidential research into the submitted documents. This also included direct contact with the submitter. In this case, the informant was therefore not truly anonymous. The research normally lasted several weeks and is therefore not suitable for publishing messages in the short term.

A need therefore exists for a short-term and anonymous publication of messages without requiring manual intervention or preliminary assessment of the messages by people. The publishing party should be able to publish messages without having to disclose his identity.

The object of the present invention is to create a concept for an automated, short-term, reliable and secure provision of messages.

This object is achieved by the features of the independent claims. Advantageous developments form the subject-matter of the dependent claims.

The methods and systems presented below can be used to communicate in client-server systems or on a client-server architecture. The methods and systems described below can be used to provide and assess messages, for example messages of a client of an author which are transmitted to the message providing and assessment system acting as the server in order to be provided there for public access, or messages to be consumed which are made publicly accessible in the message providing and assessment system, are retrieved by a client, and can be assessed by the user of the client.

The client-server architecture is the standard concept for the distribution of tasks within a network. Tasks are distributed by means of servers among different computers and may be requested on demand by a plurality of clients to perform their own tasks or parts thereof. The tasks may involve standard tasks such as, for example, sending an e-mail, receiving an e-mail, web access, etc., or specific tasks of a software package or a program. A task is referred to in the client-server model as a service.

A server is a program that offers a service. Within the client-server concept, a different program, the client, can use this service. The communication between the client and the server is dependent on the service, i.e. the service defines the data which are exchanged between the client and the server. The server is on standby in order to be able to respond at any time to the contact request from a client. Unlike the client, which actively requests a service, the server behaves passively and waits for requests. The communication rules for a service such as, for example, format, calling of the server and the meaning of the data exchanged between the server and client are defined by a protocol specific to the service concerned.

The communication interfaces or communication channels between the client and server presented below may be based on wired networks, for example using Ethernet, USB, cable, etc. The communication channels may also be based on wireless networks, for example using WLAN, WiFi, Bluetooth, infrared or other short-range communication standards. Voice-over-IP (VoIP) by means of IPv4 or IPv6, for example, can be used as data transmission protocols. The communication channels can be set up by means of the public network, for example via the Internet, a telephone network of a telephone operator, e.g. a wired network, such as, for example, a POTS, ISDN, DSL or cable network, or a wireless network such as, for example, a mobile network of a mobile operator, e.g. a cellular network, for example using a mobile standard such as e.g. LTE, UMTS, GSM, etc. Voice-over-IP by means of IPv4 or IPv6 can be used as protocols for data transmission or voice transmission via the communication network, or ATM, STM or other long-range communication standards.

The message providing and assessment system can be provided in the cloud. The cloud or cloud computing is understood here to mean the approach of providing abstracted IT infrastructures such as, for example, processing capacity, data storage, network capacities, finished software or, here, the server dynamically adapted to the requirement via a network. The abstracted IT infrastructure is also referred to as the cloud.

The methods and systems presented below may be of different types. The individual elements described can be implemented by means of hardware or software components, for example electronic components which can be manufactured through different technologies and may comprise, for example, semiconductor chips, ASICs, microprocessors, digital signal processors, integrated electrical circuits, electro-optical circuits and/or passive components.

The methods and systems presented below use services. It should be noted in this respect that the term “service” in information technology and in this document generally describes a technical, autonomous unit which bundles interrelated functionalities to form a topic area and makes it available via a clearly defined interface. Typical examples of these are e.g. Web services which make functionalities available to third parties via the Internet or Intranet, network services, system services or telecommunication services. In the following description, the services can be assigned to individual modules which perform the tasks of these services. These modules can be implemented in software or hardware.

According to a first aspect, the invention relates to a message providing and assessment system, with: a user database for storing user information; a message database for storing messages; a message interface for receiving messages; a registration module which is designed to check, in response to receiving a log-in request with a user identifier of a user, whether the user identifier matches a user identifier stored in the user database and, in the event of a match, to activate the message interface for the user to receive messages from the user; a message gathering module which is designed to assign the user identifier to the messages received from the user via the message interface and to store the messages with the user identifier in the user database; a message providing module which is designed to provide the messages stored in the message database in a memory area accessible via a public communication network; and a message assessment module which is designed to receive an assessment request for assessment of the messages provided in the memory area accessible via the public communication network with an attribute value via a communication network; and which is furthermore designed, in response to receiving the assessment request, to update an assessment attribute assigned to the user identifier of the provided messages on the basis of the received attribute value in the user database.

A message providing and assessment system of this type offers the advantage that an anonymous registration of an author can be performed on the basis of the registration module. The author can log in, for example, with an identifier which is known to him alone, and which gives no clues as to his identity. An author can thus publish messages without having to worry about his safety. The message providing and assessment system allows an automated processing of messages and information which can be processed automatically via the message interface without the need for human intervention. On the basis of the message assessment module, the messages which have previously been made publicly accessible by the message providing module can be assessed by the public, so that the publication can be performed with quantified reliability. The progression from the provision of the message by the author through to the storage in the publicly accessible memory is implemented in automated form without the need for human access. The message providing and assessment system thus guarantees a fast processing of the information and consequently a short-term, real-time publication of important contents.

With a message providing and assessment system of this type, electronic documents can also be published with an indication of an assessment attribute, for example a degree of trust, without disclosing personal information relating to the author.

In one embodiment of the message providing and assessment system according to the first aspect, the registration module is designed, in response to receiving a registration request from a user, to assign a user identifier to the user with an initial assessment attribute and to store the user identifier together with the initial assessment attribute in the user database. This offers the advantage that a different assessment attribute can be assigned to a newly registered user compared with a user who has already published many messages and has been assessed with good assessment attributes.

In one embodiment of the message providing and assessment system according to the first aspect, the message assessment module is designed to update the assessment attribute on the basis of an identification of a sender of the assessment request.

This offers the advantage that the messages made publicly available by the message providing and assessment system have a high degree of reliability, since the assessment or review of the messages is dependent on an identification of the sender of the assessment request, i.e. an identification of the consumer. The assessments of the consumers can thus be differently weighted, depending on which data relating to the consumer are available. An experienced consumer, for example, who has already produced many assessments, can be given a higher weighting than an inexperienced consumer who is submitting his first review.

In one embodiment of the message providing and assessment system according to the first aspect, the message assessment module is designed to update the assessment attribute on the basis of a first attribute value if the identification of the sender is not assignable to a user identifier stored in the user database.

This offers the advantage that even users who are not registered in the system, for example because they wish to remain anonymous or because they are using the system for the first time, can submit an assessment. The assessment of the author who has made the messages publicly accessible can then be weighted with a first assessment level, for example a smallest number of points which are to be awarded for the assessment.

In one embodiment of the message providing and assessment system according to the first aspect, the message assessment module is designed to update the assessment attribute on the basis of a second attribute value if the identification of the sender is assignable to a user identifier stored in the user database.

This offers the advantage that a user who is registered in the user database and is known to the system can submit an assessment which is weighted differently, for example more highly, than an assessment of an unregistered user. The system can thus rate a reliability of a registered user more highly than a reliability of an unregistered user, for example with a higher number of points which are to be awarded for the assessment.

In one embodiment of the message providing and assessment system according to the first aspect, the message assessment module is designed to update the assessment attribute on the basis of a third attribute value if the identification of the sender is assignable to a user identifier stored in the user database via which messages have already been provided in the memory area accessible via the public communication network.

This offers the advantage that a user who is registered in the user database, is known to the system as a user and has already published messages on one or more occasions can submit an assessment which is weighted differently, for example even more highly, than an assessment of an unregistered user or a user who is registered but has not yet published any messages. The system can thus rate the reliability of a user registered as an author even more highly than the reliability of registered or unregistered users, for example with an even higher number of points which are to be awarded for the assessment.

In one embodiment of the message providing and assessment system according to the first aspect, the message assessment module is designed to update the assessment attribute on the basis of a plurality of assessment requests with different sender identifications.

This offers the advantage that the reliability of the provision of information increases even further, since a message which has been evaluated by a plurality of persons gives far more precise clues as to the reliability of or trust in the author than a message which has been assessed by a single person only.

In one embodiment of the message providing and assessment system according to the first aspect, the message assessment module is designed to update the assessment attribute on the basis of at least one of the following criteria: assessment of a consumer from whose network address the assessment request has been dispatched, frequency with which assessment requests have been dispatched from the network address of the consumer, number of calls with the network address of the consumer to retrieve the messages provided in the memory area accessible via the public communication network, number of different network addresses from which the messages provided in the memory area accessible via the public communication network have been retrieved, level of a monetary donation indicated in the assessment request.

This offers the advantage that the reliability of the provision of information by the message providing and assessment system increases further, since these additional criteria give further clues as to the trustworthiness of the person who assesses the message or the author of the message.

In one embodiment of the message providing and assessment system according to the first aspect, the message assessment module is designed to update the assessment attribute on the basis of assessment requests from a plurality of consumers whose network addresses are assigned to a predefined group, in particular a plurality of consumers whose sender identifications are assignable to user identifications stored in the user database, or a plurality of consumers whose sender identifications are not assignable to user identifications stored in the user database.

This offers the advantage that a flexible assessment of the provided information by groups of users is enabled. The submission of the assessment is thus easier to classify and a higher-order assessment can be carried out via the individual assessments of the different groups, thereby further increasing the reliability of the assessment by the system.

In one embodiment of the message providing and assessment system according to the first aspect, the messages provided in the memory area accessible via the public communication network are retrievable without the user identifier assigned to the provided messages.

This offers the advantage that an author who has messages published by the message providing and assessment system can remain anonymous.

In one embodiment of the message providing and assessment system according to the first aspect, the messages provided in the memory area accessible via the public communication network are retrievable together with the assessment attribute stored in the user database and assigned to the user identifier.

This offers the advantage that an author who has messages published by the message providing and assessment system can remain anonymous, but an assessment of the messages relates simultaneously to his user identifier and can be assigned to the author in the message providing and assessment system in order to assess him. Messages can thus be published anonymously and a level of trust or an assessment level can simultaneously be assigned to the messages so that a better evaluation of published contents is enabled for the consumer.

In one embodiment, the message providing and assessment system comprises a reward payment module, which, is designed to set up a communication connection to a bank server in response to receiving the assessment request.

This offers the advantage that a consumer can thank an author who publishes messages which are valuable to the consumer with a reward payment in the form of a monetary donation, even though the author can continue to remain anonymous. The message providing and assessment system thus provides a platform for an automated reward payment to authors without the author having to surrender his anonymity.

In one embodiment, the message providing and assessment system comprises an authentication interface which is designed to carry out an authentication of the user before storing the identifier in the user database.

This offers the advantage that an author can authenticate himself automatically to the system without his identity becoming known to the outside world. The same applies to a user who is not an author, but reads messages from others and wishes to assess them. The reliability of the message providing and assessment system thus increases. The risk of the occurrence of fake assessments from unauthenticated groups of persons who pursue the aim of presenting a specific opinion as generally valid is reduced. The risk of fake messages is furthermore reduced if an author must first authenticate himself before he can use the system.

In one embodiment of the message providing and assessment system according to the first aspect, the user identifier comprises a pseudonym and a password.

This offers the advantage that any given character string for identifying the author which is known to the author alone can be selected via the pseudonym. The author can use this together with the password to authenticate himself to the system as an authorized party. The identity of the author thus remains secure, even if the system is hacked.

In one embodiment of the message providing and assessment system according to the first aspect, the registration module is designed to forward a network address of the user indicated in the login request from the user to the message interface if the user identifier matches a user identifier stored in the user database in order to activate the reception of messages with the network address of the user in this way.

This offers the advantage that the message providing and assessment system can grant access to registered users only for the publication of messages. The provision of messages thus becomes more secure, since the system resources cannot be used without prior registration.

According to a second aspect, the invention relates to a method for providing and assessing messages, with the following steps: receiving a login request with a user identifier of a user; in response to receiving the login request: checking whether the user identifier matches a user identifier stored in the user database and, in the event of a match: activating a message interface for the user to receive messages from the user; allocating the user identifier to the messages received from the user via the message interface and storing the messages with the user identifier in a message database; providing the messages stored in the message database in a memory area accessible via a public communication network; receiving an assessment request for assessment of the messages provided in the memory area accessible via the public communications network with an attribute value via a communication network; and updating an assessment attribute assigned to the user identifier of the provided messages on the basis of the received attribute value in the user database.

A method of this type offers the advantage that an author can be registered anonymously on the basis of the registration procedure. The author can log in, for example, with an identifier which is known to him alone and which gives no clues as to his identity. An author can thus publish messages without having to worry about his safety. On the basis of the message process, the method allows an automated processing of messages and information which can be processed automatically via the message interface without the need for human intervention. Messages which have previously been made publicly accessible can be assessed by the public and provided with this assessment, so that the publication can be take place with quantifiable reliability. The path from the provision of the message by the author through to the storage in the publicly accessible memory area is implemented in automated form without the need for human access. The method thus guarantees a fast processing of the information and consequently a short-term, real-time publication of important contents.

Further embodiments will be explained with reference to the attached drawings. In the drawings:

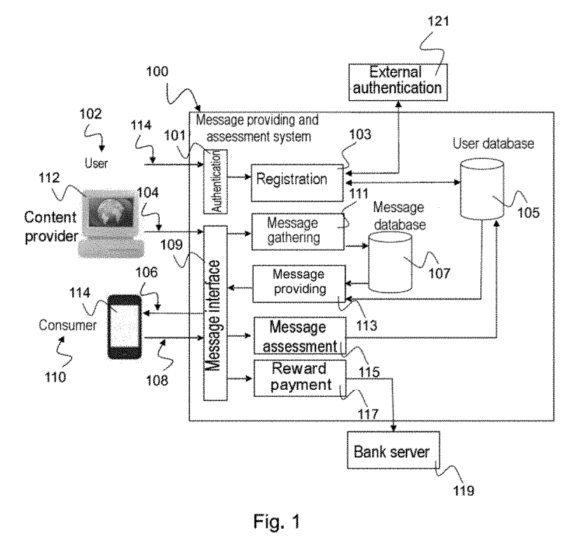

FIG. 1 shows a schematic representation of a message providing and assessment system 100 according to one embodiment;

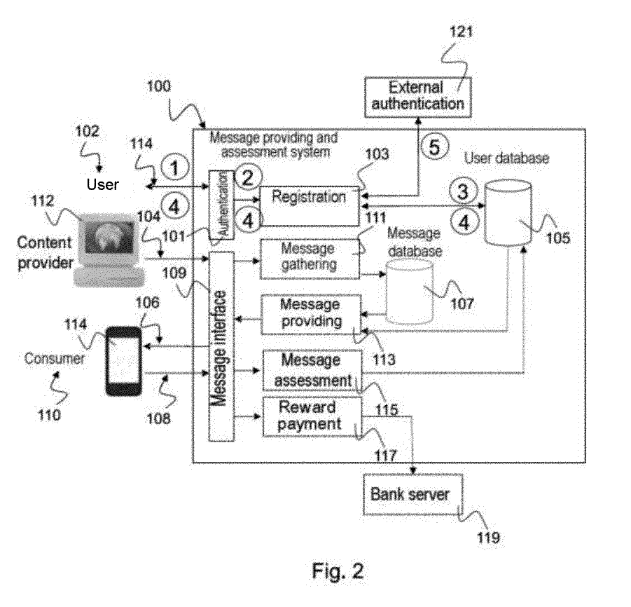

FIG. 2 shows a schematic representation of the message providing and assessment system 100, highlighting the components that are active during the registration of a user;

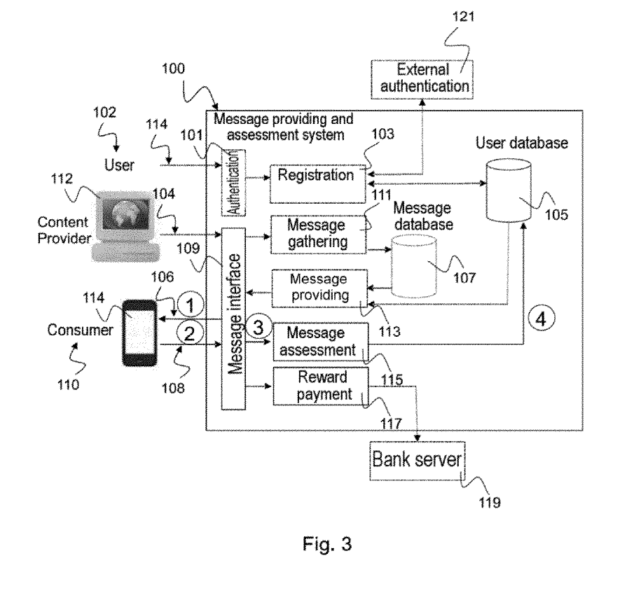

FIG. 3 shows a schematic representation of the message providing and assessment system 100, highlighting the components that are active during the assessment of a message by a consumer;

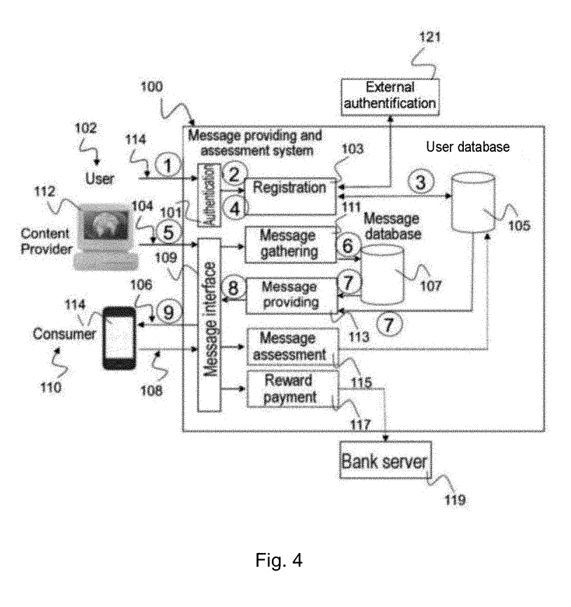

FIG. 4 shows a schematic representation of the message providing and assessment system 100, highlighting the components that are active during the provision of the message that is to be published in a publicly accessible memory area;

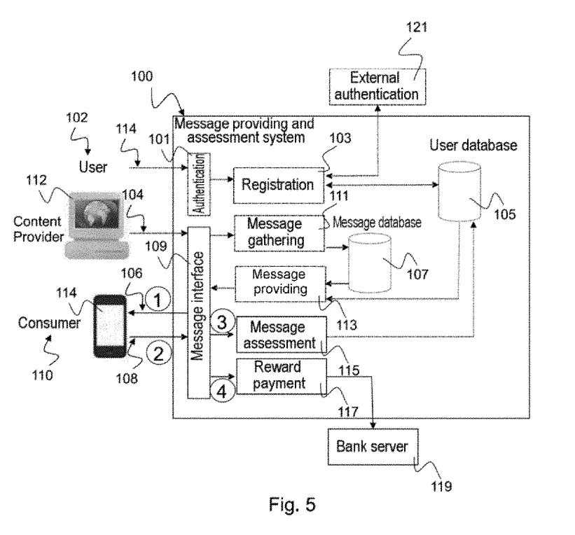

FIG. 5 shows a schematic representation of the message providing and assessment system 100, highlighting the components that are active during the retrieval and assessment of messages by a consumer;

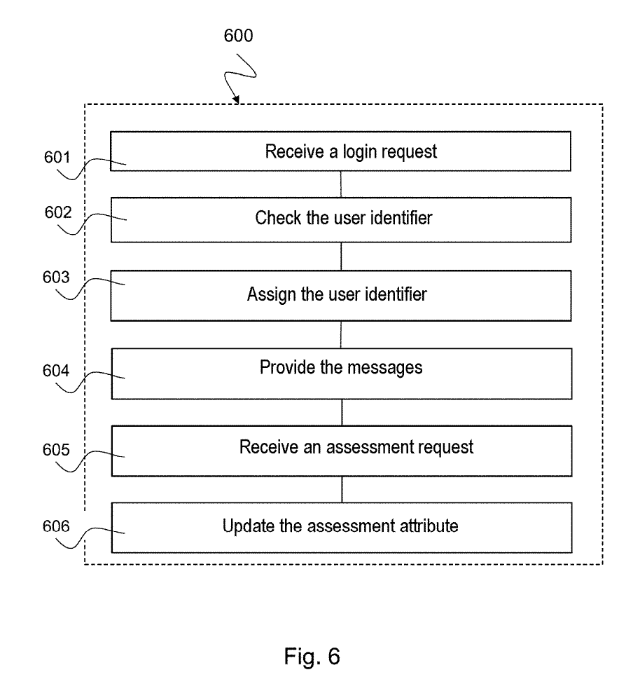

FIG. 6 shows a schematic representation of a method 600 for providing and assessing messages according to one embodiment.

In the following detailed description, reference is made to the attached drawings which form a part thereof and in which specific embodiments in which the invention can be implemented are shown by way of illustration. Other embodiments can obviously also be used and structural or logical modifications can be made without deviating from the concept of the present invention. The following detailed description is therefore not to be understood in a limiting sense. It is furthermore obvious that the features of the different example embodiments described herein can be combined with one another, unless specifically indicated otherwise.

The aspects and embodiments are described with reference to the drawings, wherein the same reference numbers generally relate to the same elements. Numerous specific details are set out in the following description for explanatory purposes in order to convey an in-depth understanding of one or more aspects of the invention. However, it may be obvious to a person skilled in the art that one or more aspects or embodiments can be implemented with fewer specific details. In other cases, known structures and elements are presented in schematic form in order to simplify the description of one or more aspects of the embodiments. Other embodiments can obviously be used and structural or logical modifications can be made without deviating from the concept of the present invention.

Even though a specific feature or a specific aspect of one embodiment relating to only one of a plurality of implementations may be disclosed, a feature or aspect of this type can furthermore be combined with one or more other features or aspects of the other implementations, as may be desired and advantageous for a given or specific application or aspect. Furthermore, to the extent that the expressions “contain”, “have”, “with” or other variants thereof are used in either the detailed description or the claims, such expressions are intended to be inclusive in a manner similar to the expression “comprise”. The expressions “coupled ” and “connected” can be used together with derivations thereof. Expressions of this type are obviously used to indicate that two elements interwork or interact with one another regardless of whether they are in direct physical or electrical contact with one another or are not in direct contact with one another. The expression “by way of example” is furthermore to be understood merely as an example rather than the designation for the best or optimum. The following description is therefore not to be understood in a restricting sense.

FIG. 1 shows a schematic representation of a message providing and assessment system 100 according to one embodiment.

The message providing and assessment system 100 comprises a user database 105 for storing user information 114, a message database 107 for storing messages 104, a message interface 109 for receiving messages 104, a registration module 103 for registering users 102, a message gathering module 111 for gathering messages 104, a message providing module 113 for providing messages which are to be published in a memory area accessible via a public communication network and a message assessment module 115 for assessing messages made publicly accessible.

The message providing and assessment system 100 may furthermore comprise an authentication interface 101 for authenticating users 102, and also a reward payment module 117 via which a consumer 110 can make a reward payment to an author or user 102.

The registration module 103 serves to check, in response to receiving a registration request with a user identifier of a user 102, whether the user identifier matches a user identifier stored in the user database and, in the event of a match, to activate the message interface for the user 102 to receive messages from the user 102.

The message gathering module 111 serves to assign the user identifier to the messages 104 received from the user via the message interface 109 and to store the messages 104 with the user identifier in the message database 107.

The message providing module 113 serves to provide the messages stored in the message database 107 in a memory area accessible via a public communication network.

The message assessment module 115 serves to receive an assessment request for assessment of the messages provided in the memory area accessible via the public communications network with an attribute value via a communication network; and, in response to receiving the assessment request, to update an assessment attribute assigned to the user identifier of the provided messages on the basis of the received attribute value in the user database 105.

The registration module 103 can, in response to receiving a registration request from a user 102, assign a user identifier to the user with an initial assessment attribute and store the user identifier together with the initial assessment attribute in the user database 105.

The message assessment module 115 can update the assessment attribute on the basis of an identification of a sender of the assessment request.

The message assessment module 115 can update the assessment attribute on the basis of a first attribute value if the identification of the sender is not assignable to a user identifier stored in the user database 105.

The message assessment module 115 can update the assessment attribute on the basis of a second attribute value if the identification of the sender is assignable to a user identifier stored in the user database 105.

The message assessment module 115 can update the assessment attribute on the basis of a third attribute value if the identification of the sender is assignable to a user identifier stored in the user database 105 via which messages have already been provided in the memory area accessible via the public communication network.

The message assessment module 115 can update the assessment attribute on the basis of a plurality of assessment requests with different sender identifications.

The message assessment module 115 can update the assessment attribute on the basis of at least one of the following criteria: assessment of a consumer 110 from whose network address the assessment request has been dispatched, frequency with which assessment requests have been dispatched from the network address of the consumer 10, number of calls with the network address of the consumer 110 to retrieve the messages provided in the memory area accessible via the public communication network, number of different network addresses from which the messages provided in the memory area accessible via the public communication network have been retrieved, level of a monetary donation indicated in the assessment request.

The message assessment module 115 can update the assessment attribute on the basis of assessment requests from a plurality of consumers 110 whose network addresses are assigned to a predefined group, in particular a plurality of consumers whose sender identifications are assignable to user identifications stored in the user database 105, or a plurality of consumers 110 whose sender identifications are not assignable to user identifications stored in the user database 105.

The messages provided in the memory area accessible via the public communication network can be retrieved with or without the user identifier assigned to the provided messages. The messages provided in the memory area accessible via the public communication network can be retrieved together with the assessment attribute stored in the user database 105 and assigned to the user identifier. Alternatively, the provided messages can also be retrieved without the assessment attribute assigned to the user identifier. This corresponds to the case in which the message providing and assessment system 100 provides messages of a sufficient quality only, without the individual assessment attribute being published together with the messages.

The reward payment module 117 can set up a communication connection to a bank server 119 in response to receiving the assessment request from a consumer 110 in order to make a reward payment from the consumer, for example in the form of a monetary donation, to the author of the published messages.

The authentication interface 101 can perform an authentication of the user 102 before storing the user identifier in the user database 105.

The user identifier may comprise, for example, a pseudonym and a password.

If the user identifier matches a user identifier stored in the user database 105, the registration module 103 can forward a network address of the user 102 indicated in the login request from the user 102 to the message interface 109 in order to activate the reception of messages with the network address of the user 102.

The communication system shown in FIG. 1 may thus represent a system for electronic information publication, comprising an access-secured server computer system, i.e. the message providing and assessment system 100 (also referred to as a trusted, anonymous publication platform TAPP or platform) which provides a service and can be connected via the Internet or Intranet to the client computer system 112 and allows no access whatsoever, other than via defined interfaces.

The access security can be achieved through different measures. On the one hand, it must be specified that the computer system 100 is protected by corresponding firewalls and gateways. It should furthermore be noted that the operating system is hardened and provides defined ports only via which the communication can take place. It must also be ensured that the server computer system 100 is stored in a physically secured area, so that physical access is not possible. This normally involves a known computer system on which corresponding operating systems run which can provide services on the Internet.

A user 102, 110 of the platform 100 is designated here as a client. There are two (or more) groups of possible users, on the one hand the publishing party 102 and on the other hand the consumer 110. The publishing party 102 provides information for publication on the platform 100 and is referred to below as the content provider. The consumer 110 retrieves the information from the platform 100 and is referred to below as the content consumer.

The communication between the client 102, 110 and the platform 100 can take place, for example, via Web services.

In order to provide the consumer with a facility to assess the intrinsic value of published information, despite the anonymity of the publishing party, a level of trust or assessment information can be assigned to the publishing party. The level of trust can be presented with the publication, so that a consumer can decide for himself how much trust he places in the information itself.

The trustworthiness of a publishing party can thus be defined from the trustworthiness of a series of published information. A measure of trust can in turn be assigned to the publishing party via this indication.

Individual example embodiments of the components of the message providing and assessment system 100 are described in detail below.

The authentication interface 101 is the interface which a user 102 can use for login or initial registration on the system 100.

The registration module 103 or the registration service is the component which administers the user information. A user can thus be given the facility to set up an account for himself on the system 100 during the initial registration. Here, he can specify a login name, an outwardly visible name, the pseudonym and a password. This information does not need to have a connection to his real identity. If the user selects the details accordingly, no clue as to the real identity is possible. The platform 100 itself cannot therefore unintentionally, intentionally or unavoidably forward information relating to real persons.

Password rules of the system such as the minimum length and character set for passwords can be checked in the registration module 103. The registration module 103 can perform the login and password check during a subsequent visit of the user.

External authentication services 121 can optionally also be incorporated.

It is possible to set up group accounts e.g. for an entire editorial team and to assign individual accounts or individual identifiers to them. In order to prevent misuse of the platform 100, which may arise, for example, if a user places advertising there, the following options can be provided by the registration module 103:

A newly logged in user may not submit content for publication immediately after the registration, but either after a definable waiting time, e.g. 3 months, and after the user has submitted a specific number of assessments for other articles or messages, or following an invitation of an existing publishing party with a minimum confidentiality level.

The user database 105 contains all user information and the current level of trust of a user.

The message interface 109 forms the central access to the content of the platform 100. The content provider or publishing party 102 submits his messages to the system 100 via this interface. The system 100 presents the messages, for example on a website. The system can offer the reader the facility to display messages for specific keywords or specific trust levels only.

The content consumer (reader) or consumer 110 can read the messages. The selection of the presented articles can be restricted via filters to keywords (tags). A follower function can be used with which the reader 110 can specify that he should always be informed automatically about articles of a publishing party 102. The content consumer 110 can assess the intrinsic value of published information on the basis of the level of trust indicated for the author 102. The content consumer 110 can optionally pay a monetary sum to the content provider 102.

The message gathering module 111 or the message gathering service can collect the incoming messages and carry out plausibility checks and store the checked messages in a database, for example the message database 107. The publishing party has the facility to mark specific keywords in the text, referred to as tags.

The entered contents can be stored in the message database 107.

The message providing module 113 or the message providing service or publication service processes the information for the content consumer 110. For this purpose, the message can be supplemented with the pseudonym and the level of trust of the publishing party 102 and can then be published. Alternatively, only the message with the level of trust of the publishing party 102, but without the pseudonym, can be published.

The message assessment module 115 or the message assessment service serves to assess the published messages. After reading information, every reader can submit his assessment of the trustworthiness of the information. He can, for example, award between 0 and n points, and the following, for example, can apply: An anonymous reader can award n=1 points; a registered user can award n=3 (or any other number of) points; other authors can award n points, where n may correspond to their own level of trust. These points can be credited to the author of the message as trust points.

In addition, the message assessment service 115 can make use of further sources to specify the level of trust, as described below: The respectability of the “referrer” (for example a network address of a website) from which the message has been retrieved. This means the website from which the information has been referred to on the TAPP platform 100. If, for example, references are made from the pages of recognized message services to a TAPP publication, this can be rated as a measure of trustworthiness. Further sources may be the following: The frequency of the referrer from which the message has been retrieved; the number of retrievals of the message; the number of different messages with the same tags; the amount of a monetary sum transferred for a message.

Assessments can be made by different groups, for example by a jury, by registered users or by anonymous users. The operator of the system may appoint a jury which carries out an assessment. Alternatively, assessments from registered users only or assessments from anonymous users only may be rated. These further factors may also be attributed to the degree of validity of an author.

The reward payment module 117 or the reward payment service can be used to pay a monetary sum to an author for his contribution. This can be implemented, for example, via an external service provider, for example a bank server 119 via which a transfer of the monetary sum can be credited to the account of the author concerned.

The message providing and assessment system 100 can be implemented on a computer, for example a server. The computer may be a PC, for example a PC of a computer network. The computer may be implemented as a chip, an ASIC, a microprocessor or a signal processor, and may be disposed in a computer network.

FIG. 2 shows a schematic representation of the message providing and assessment system 100, highlighting the components that are active during the registration of a user.

Every potential publishing party can log in to the platform 100. In one embodiment of the message providing and assessment system 100, a return verification, e.g. via an email, is not provided in order to be able to guarantee anonymity in this way. During the registration, the potential publishing party can be given a pseudonym. In a first possible embodiment, the publishing party can select his pseudonym for himself. In a second possible alternative embodiment, the system 100 or the registration module 103 can randomly generate the pseudonym. Group identifiers, for example for organizations, can be created and individual identifiers can in turn be assigned to them.

The individual steps which may be carried out during a registration by the registration module 103 are indicated in FIG. 2 by way of example with steps 1 to 5. In step 1, a user 102 wishes to register and calls an authentication service on the website via the authentication interface 101.

In step 2, the website forwards the request to the registration service 103 which controls the dialogue for selecting unique pseudonyms and a password.

In step 3, the information is stored in the user database 105.

In step 4, the user 102 receives an acknowledgement of the completed registration.

In step 5, external authentication services 121 can optionally be incorporated.

FIG. 3 shows a schematic representation of the message providing and assessment system 100, highlighting the components that are active during the assessment of a message by a consumer.

A newly registered publishing party can, for example, be given a standard level of trust. Following the publication of information, a consumer 110 (or a jury or editorial team as described above in connection with FIG. 1) can assess the publication in terms of its intrinsic value. Further criteria as described above in connection with FIG. 1 can supplement the validity value. A new level of trust of the publishing party can be derived from the sum of the indicated intrinsic values and can be stored in the user database 105.

The individual steps which may be carried out during a message assessment by the message registration module 115 are indicated in FIG. 3 by way of example with steps 1 to 4.

In step 1, a consumer 110 reads published information.

In step 2, the website gives the consumer 110 an assessment function which the consumer fulfills.

In step 3, the completed assessment is forwarded by the consumer 110 to the message assessment service 115, which defines or calculates an overall level of trust from the different user reports.

In step 4, the result is assigned to the publishing party 102 and is stored in the user database 105.

FIG. 4 shows a schematic representation of the message providing and assessment system 100, highlighting the components that are active during the provision of the message that is to be published in a publicly accessible memory area.

The individual steps which may be carried out during a message provision in a publicly accessible area by the message registration module 113 are indicated in FIG. 4 by way of example with steps 1 to 9.

In step 1, a publishing party logs 102 in to the system 100 with his pseudonym and password.

In step 2, the information is forwarded to the registration service 103.

In step 3, the registration service 103 checks the login against information in the user database 105.

In step 4, in the event of a successful check, the publishing party 102 gains access to the platform 100.

In step 5, the publishing party 102 gathers the information 104 to be published in the message interface 109, also referred to as the user interface for content.

In step 6, the information is stored in the message database 107.

In step 7, the publication service or message providing service 113 supplements the publication with the level of trust of the publishing party 102 stored in the user database 105.

In step 8, the information is provided for publication via the message providing module 113, i.e. is stored in a publicly accessible area, for example a memory area which can be accessed from outside.

In step 9, the information can be consumed by the consumer 110.

FIG. 5 shows a schematic representation of the message providing and assessment system 100, highlighting the components that are active during the retrieval and assessment of messages by a consumer.

The individual steps which may be carried out during a consumption and assessment of publicly provided messages by the message assessment module 115 and optionally by the reward payment module 117 are shown by way of example in FIG. 5 with steps 1 to 4.

In step 1, a consumer 110 reads the messages or information provided via the message providing module 113.

In step 2, the consumer 110 provides his feedback or assessment 108 via the provided assessment function.

In step 3, the information is processed in the message assessment module 115.

In an optional step 4, the consumer 110 can pay a monetary sum to the publishing party 102 via an external platform, for example a bank server 119.

FIG. 6 shows a schematic representation of a method 600 for providing and assessing messages according to one embodiment.

The method 600 has the following steps:

A first step 601 comprises receiving 601 a login request with a user identifier of a user, for example via an authentication interface 101, as described above in connection with FIGS. 1 to 5.

A second step 602 comprises, in response to receiving 603 the login request: checking 602 whether the user identifier matches a user identifier stored in the user database 105 and, in the event of a match: activating a message interface for the user for receiving messages from the user, for example via a message gathering module 111, as described above in connection with FIGS. 1 to 5.

A third step 603 comprises allocating 605 the user identifier to the messages received from the user via the message interface 109 and storing the messages with the user identifier in a message database 107, for example via a message gathering module 111, as described above in connection with FIGS. 1 to 5.

A fourth step 604 comprises providing 604 the messages stored in the message database in a memory area accessible via a public communication network, for example via a message providing module 113, as described above in connection with FIGS. 1 to 5.

A fifth step 605 comprises receiving 605 an assessment request for assessment of the messages provided in the memory area accessible via a public communication network with an attribute value via a communication network, for example via a message assessment module 115, as described above in connection with FIGS. 1 to 5.

A sixth step 606 comprises updating 606 an assessment attribute assigned to the user identifier of the provided messages on the basis of the received attribute value in the user database 105, for example via a message assessment module 115, as described above in connection with FIGS. 1 to 5.

A longer time interval, for example a response time with which the consumer reads and assesses a newly provided message, may occur between the provision 604 of the messages stored in the message database and the reception 605 of the assessment request.

The method 600 may furthermore have the following steps:

receiving a registration request of a user with a user identifier, for example via a registration module 103 or a registration service, as described above in connection with FIGS. 1 to 5.

In response to receiving the registration request: assigning initial assessment information to the user identifier and storing the user identifier together with the initial assessment information in the user database, for example via a registration module 103 or a registration service, as described above in connection with FIGS. 1 to 5.

One aspect of the invention also comprises a computer program product which can be loaded directly into the internal memory of a digital computer and comprises software code segments with which the method 600 described in connection with FIG. 6 can be carried out when the product runs on a computer. The computer program product may be stored on a computer-compatible medium and may comprise the following: computer readable program means which cause a computer to receive 601 a login request with a user identifier of a user; in response to receiving 603 the login request, to check 602 whether the user identifier matches a user identifier stored in the user database 105 and, in the event of a match, to activate a message interface for the user to receive messages from the user; to assign 603 the user identifier to the messages received from the user via the message interface 109 and to store the messages with the user identifier in a message database 107; to provide 604 the messages stored in the message database in a memory area accessible via a public communication network; to receive 605 an assessment request for assessment of the messages provided in the memory area accessible via the public communication network with an attribute value via a communication network; and to update 606 an assessment attribute assigned to the user identifier of the provided messages on the basis of the received attribute value in the user database 105.

The computer may be a PC, for example a PC of a computer network. The computer may be implemented as a chip, an ASIC, a microprocessor or a signal processor and may be disposed in a computer network, for example as a processor of a computer server, as described in connection with FIGS. 1 to 5.

It is obvious that the features of the different embodiments described herein by way of example can be combined with one another, unless specifically indicated otherwise. As indicated in the description and in the drawings, individual elements which have been shown as connected do not have to be directly connected to one another; intermediate elements may be provided between the connected elements. It is furthermore obvious that embodiments of the invention may be implemented in individual circuits, partially integrated circuits or completely integrated circuits or programming means. The term “for example” is merely meant as an example and not as the best or optimum. Specific embodiments have been illustrated and described herein, but it is obvious to the person skilled in the art that a multiplicity of alternative and/or similar implementations can be substituted for the embodiments shown and described without deviating from the concept of the present invention.

### REFERENCE NUMBER LIST

100: Message providing an assessment system according to one embodiment
101: Authentication interface
102: User
103: Registration module
104: Messages
105: User database
106: Messages provided in a publicly accessible memory area
107: Message database
108: Assessment information
109: Message interface
110: Consumer
111: Message gathering module
113: Message providing module
114: User information
115: Message assessment module
117: Reward payment module
119: Bank server or financial service provider service module
600: Method for providing and assessing messages according to one embodiment
601: Receive a login request
602: Check the user identifier
603: Assign the user identifier
604: Provide the messages
605: Receive an assessment request
606: Update the assessment attribute

1.-15. (canceled)

16. A message providing and assessment system, with
a user database for storing user information;
a message database for storing messages;
a message interface for receiving messages;
a registration module which is configured to check, in response to receiving a log in request with a user identifier of a user, whether the user identifier matches a user identifier stored in the user database and, in the event of a match, to activate the message interface for the user to receive messages from the user;
a message gathering module which is configured to assign the user identifier to the messages received from the user via the message interface and to store the messages with the user identifier in the message database;
a message providing module which is configured to provide the messages stored in the message database in a memory area accessible via a public communication network; and
a message assessment module, which is configured,
to receive an assessment request for assessment of the messages provided in the memory area accessible via the public communication network with an attribute value via a communication network; and which is furthermore configured,
in response to receiving the assessment request, to update an assessment attribute assigned to the user identifier of the provided messages on the basis of the received attribute value in the user database.

17. The message providing and assessment system as claimed in claim 16, wherein the registration module is configured, in response to receiving a registration request from a user, to assign a user identifier to the user with an initial assessment attribute and store the user identifier together with the initial assessment attribute in the user database.

18. The message providing and assessment system as claimed in claim 16, wherein the message assessment module is configured to update the assessment attribute on the basis of an identification of a sender of the assessment request.

19. The message providing and assessment system as claimed in claim 18, wherein the message assessment module is configured to update the assessment attribute on the basis of a first attribute value if the identification of the sender is not assignable to a user identifier stored in the user database.

20. The message providing and assessment system as claimed in claim 18, wherein the message assessment module is configured to update the assessment attribute on the basis of a second attribute value if the identification of the sender is assignable to a user identifier stored in the user database.

21. The message providing and assessment system as claimed in claim 18, wherein the message assessment module is configured to update the assessment attribute on the basis of a third attribute value if the identification of the sender is assignable to a user identifier stored in the user database via which messages have already been provided in the memory area accessible via the public communication network.

22. The message providing and assessment system as claimed in claim 16, wherein the message assessment module is configured to update the assessment attribute on the basis of a plurality of assessment requests with different sender identifications.

23. The message providing and assessment system as claimed in claim 16, wherein the message assessment module is configured to update the assessment attribute on the basis of assessment requests from a plurality of consumers whose network addresses are assigned to a predefined group, in particular a plurality of consumers whose sender identifications are assignable to user identifications stored in the user database, or a plurality of consumers whose sender identifications are not assignable to user identifications stored in the user database.

24. The message providing and assessment system as claimed in claim 16, wherein the messages provided in the memory area accessible via the public communication network are retrievable without the user identifier assigned to the provided messages.

25. The message providing and assessment system as claimed in claim 16, wherein the messages provided in the memory area accessible via the public communication network are retrievable together with the assessment attribute stored in the user database and assigned to the user identifier.

26. The message providing and assessment system as claimed in claim 16, with a reward payment module which is configured to initiate a communication connection to a bank server in response to receiving the assessment request.

27. The message providing and assessment system as claimed in claim 17, with an authentication interface which is configured to perform an authentication of the user before storing the user identifier in the user database.

28. The message providing and assessment system as claimed in claim 16, wherein the user identifier comprises a pseudonym and a password.

29. The message providing and assessment system as claimed in claim 16, wherein the registration module is configured, if the user identifier matches a user identifier stored in the user database, to forward a network address of the user indicated in the login request from the user to the message interface in order to activate the reception of messages with the network address of the user.

30. A method for providing and assessing messages, with the following steps:
receiving a login request with a user identifier of a user;
in response to receiving the login request: checking whether the user identifier matches a user identifier stored in the user database and, in the event of a match: activating a message interface for the user to receive messages from the user;
assigning the user identifier to the messages received from the user via the message interface and storing the messages with the user identifier in a message database;
providing the messages stored in the message database in a memory area accessible via a public communication network;
receiving an assessment request for assessment of the messages provided in the memory area accessible via the public communication network with an attribute value via a communication network; and
updating an assessment attribute assigned to the user identifier of the provided messages on the basis of the received attribute value in the user database.
